(19) United States
(12) Patent Application Publication
(10) Pub. No.: US 2026/0332034 A1
(43) Pub. Date: Oct. 22, 2026

(54) ELECTRIC POWER CONVERTING DEVICE, AND METHOD FOR MANUFACTURING ELECTRIC POWER CONVERTING DEVICE

(71) Applicant: Hitachi Astemo, Ltd., Hitachinaka-shi, Ibaraki (JP)

(72) Inventors: Yusaku KATSUBE, Tokyo (JP); Atsunari HAMAGUCHI, Hitachinaka-shi, Ibaraki (JP); Hirofumi SHIMIZU, Hitachinaka-shi, Ibaraki (JP)

(21) Appl. No.: 18/993,872

(22) PCT Filed: May 11, 2023
(86) PCT No.: PCT/JP2023/017798

§ 371 Date: Jan. 13, 2025

(30) Foreign Application Priority Data
Aug. 12, 2022 (JP) 2022-129019

(51) Int. Cl. H02M 1/14; H02M 1/32; H02M 7/00; H02P 27/05

(52) U.S. Cl. CPC H02M 1/14; H02M 1/32; H02M 7/003; H02P 27/05

(57) ABSTRACT

A power conversion device including: a power module including a switching element that converts DC power into AC power; a DC bus bar that supplies the DC power to the switching element; a housing that is made of metal and houses the switching element; and a capacitor that connects the DC bus bar and the housing, wherein the capacitor and the housing are electrically connected with a first connection member that is a conductive adhesive.

### TECHNICAL FIELD

The present invention relates to a power conversion device and a method for manufacturing the power conversion device.

### BACKGROUND ART

In a power conversion device, large common mode noise leaks to a battery system due to resonance of a mounted Y capacitor. This may cause a problem that the EMC regulation (noise standard) cannot be satisfied. As a measure against such a problem, for example, PTL 1 below discloses a semiconductor device in which noise is reduced by adjusting an electrostatic capacitance of an insulating layer and an inductance of an inductor by connecting the inductor to a water path with a conductive sheet.

### CITATION LIST

### Patent Literature

PTL 1: JP 2015-223010 A

### SUMMARY OF INVENTION

### Technical Problem

Conventionally, as a countermeasure against resonance of a Y capacitor, there have been problems as follows. In order to provide large resistance, for example, it is necessary to change a physical property value of a connection member for the Y capacitor to such a value that increases low efficiency of the connection member. Even when a damping resistor is provided in series to reduce noise, cost is increased because the resistance is mounted by using a PCB substrate. Furthermore, even when no damping resistor is used, the GND terminal of the Y capacitor is connected to the housing via a metal member for welding, and there is also a concern about an increase in cost of the metal member for welding and mounting.

An object of the present invention is to provide a power conversion device and a method for manufacturing the power conversion device that achieve both low noise and low cost.

### Solution to Problem

A power conversion device including: a power module including a switching element that converts DC power into AC power; a DC bus bar that supplies the DC power to the switching element; a housing that is made of metal and houses the switching element; and a capacitor that connects the DC bus bar and the housing, IN the capacitor and the housing are electrically connected with a first connection member that is a conductive adhesive.

Furthermore, a power conversion device of the present invention adopts a method for manufacturing a power conversion device that includes: a DC bus bar that supplies DC power to a switching element that converts the DC power into AC power; a housing that is made of metal and houses the switching element; and a capacitor that connects the DC bus bar and the housing, the method including: forming on the housing a step portion that protrudes on an upper part of the housing; connecting electrically the capacitor and the step portion with a first connection member that is a thermosetting resin and a conductive adhesive and fills a first adhesive container; connecting electrically the capacitor and the housing with a second connection member that fills a filling portion formed, in the housing, at a portion different from the step portion; and heating simultaneously the first connection member and the second connection member.

### Advantageous Effects of Invention

The present invention can provide a power conversion device and a method for manufacturing the power conversion device that achieve both low noise and low cost.

### BRIEF DESCRIPTION OF DRAWINGS

FIG. 1 is an explanatory diagram of a power conversion device mounted on a vehicle and other mounted components related to driving.

FIG. 2 is a functional block diagram of the power conversion device in FIG. 1.

FIG. 3 is a configuration diagram of a filter circuit included in the power conversion device of FIG. 2.

FIG. 4 is an explanatory diagram of a filter circuit according to an embodiment of the present invention.

FIG. 5 is a cross-sectional view taken along line A-A in FIG. 4.

FIG. 6 is an explanatory diagram of a resin lid included in a filter circuit according to an embodiment of the present invention.

FIG. 7 is a view illustrating a modification of a first connection member container according to an embodiment of the present invention.

FIG. 8 is a diagram of a filter circuit to which FIG. 7 is applied.

FIG. 9 illustrates a first modification.

FIG. 10 illustrates a second modification.

FIG. 11 illustrates a third modification.

FIG. 12 illustrates a fourth modification.

### DESCRIPTION OF EMBODIMENTS

Hereinafter, an embodiment of the present invention will be described with reference to the drawings. The following description and drawings are examples for describing the present invention, and omission and simplification are made as appropriate to simplify the description. The present invention can be carried out in various other forms. Unless otherwise specified, each component may be singular or plural.

In some cases, positions, sizes, shapes, ranges, and the like of the components illustrated in the drawings do not represent actual positions, sizes, shapes, ranges, and the like for easier understanding of the invention. Therefore, the present invention is not necessarily limited by the positions, sizes, shapes, ranges, or the like disclosed in the drawings.

### Overall Configuration of an Embodiment and a Device of the Present Invention

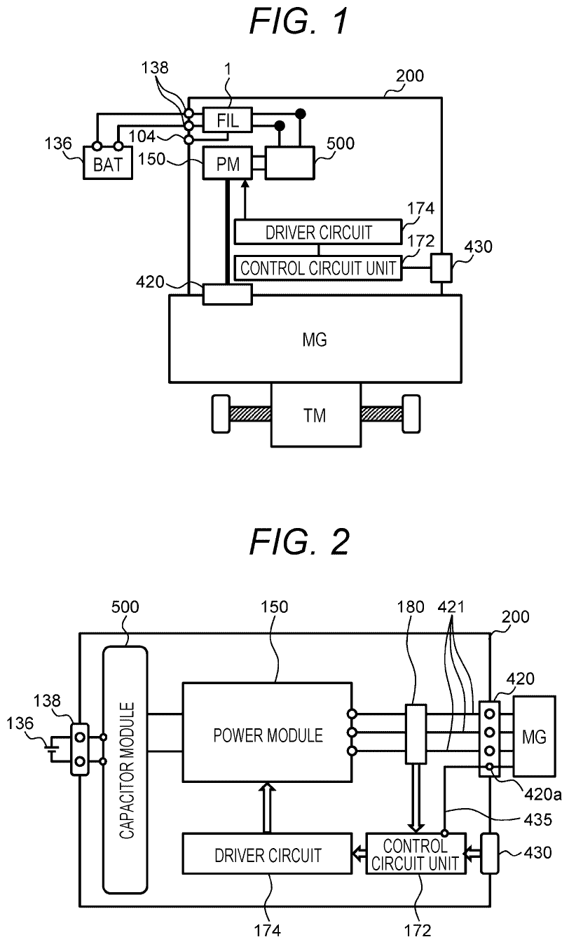

### (FIG. 1)

On a vehicle, there are mounted a power conversion device 200, a battery system 136, a motor generator MG (Motor Generator), and a transmission TM (Transmission. The power conversion device 200 includes thereinside a filter circuit 1, a smoothing capacitor 500, a power module 150, a driver circuit 174, and a control circuit unit 172.

The battery system 136 stores electric energy necessary for traveling of the vehicle, and supplies DC power to the power conversion device 200. A DC connector 138 is a connector used to input the DC power of the battery system 136 to the power conversion device 200.

The filter circuit 1 filters noise generated in the power conversion device 200 to prevent the noise from being mixed into the battery system 136. A smoothing capacitor 500 smooths the DC power from the battery system 136 and thereby supplies stable DC power to an inverter circuit unit of the power module 150.

The inverter circuit unit included in the power module 150 includes a switching element that converts DC power into AC power. The control circuit unit 172 receives a command from a host control device (not shown) via a control connector 430, and transmits a drive signal to the driver circuit 174 on a driver substrate. The driver circuit 174 drives the power module 150 according to a signal from the control circuit unit 172 on a control board. As a result, the switching element of the inverter circuit unit included in the power module 150 operates and outputs an AC current to the motor generator MG.

An AC terminal 420 transmits to the motor generator MG a three-phase AC that is output from the power module 150. Power generated by the motor generator MG is transmitted to tires via the transmission TM.

### (FIG. 2)

A current sensor 180 is installed in the vicinity of an AC bus bar 421 in order to detect the AC current that is output from the power module 150 to the motor generator MG. A current value detected by the current sensor 180 is input to the control circuit unit 172 and is used for feedback processing. A motor control connector 420a receives a signal from the motor generator MG1 and transmits the signal to the control circuit unit 172 through a motor control wire 435.

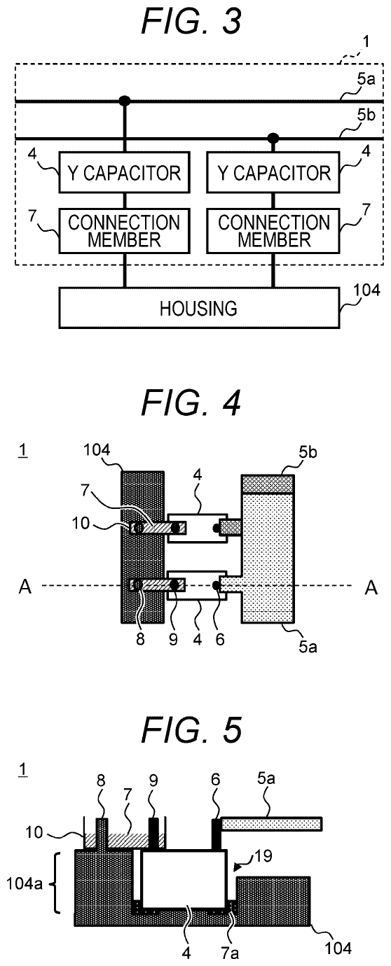

### (FIG. 3)

The filter circuit 1 includes: a Y capacitor 4 connected to a positive-pole bus bar 5a that supplies DC power to the switching element; a Y capacitor 4 connected to a negative-pole bus bar 5b; and first connection members 7 that connect respective ones of the Y capacitors 4 to a housing 104. The Y capacitors 4 serve as noise removal capacitors of the power conversion device 200.

### (FIGS. 4 and 5)

The filter circuit 1 includes: a DC bus bar 5 that supplies DC power to the switching element; a housing 104 that is made of metal and houses the switching element; and Y capacitors 4 that connect the DC bus bar 5 and the housing 104. The Y capacitors 4 are electrically connected to the housing 104 with the first connection members 7 that are a conductive adhesive.

The Y capacitors 4 each have a GND terminal 9 (first terminal) and an HV terminal 6 (second terminal). The HV terminal 6 of one of the Y capacitors 4 is connected to a positive-pole bus bar 5a of an HV bus bar (DC bus bar), and the HV terminal 6 of the other one of Y capacitors 4 is connected to a negative-pole bus bar 5b. The GND terminals 9 of the Y capacitors 4 are connected to the first connection members 7. The first connection members 7 are a conductive adhesive and fill first adhesive containers 10.

The housing 104 has a step portion 104a protruding on its upper part. The bottom surfaces of the first adhesive containers 10 are in contact with the step portion 104a. The first adhesive containers 10 are each non-conductive and have through-holes each of which the GND terminal 9 of one of the Y capacitors 4 and a positioning pin 8 of the housing 104 pass through. Each positioning pin 8 passes through the through-hole of one of the first adhesive containers 10 and is connected to the step portion 104a. As a result, while a return current to the housing 104 flows, inside the first connection members 7, from the GND terminals 9 to the positioning pins 8, a current that returns to a noise source (switching source) while spreading from the positioning pins 8 to the entire housing 104 has an opposite direction component. As a result, a magnetic field can be canceled by the mutual currents, thereby achieving low inductance. As a result, noise can be reduced.

Since the first adhesive containers 10 are filled with the first connection members 7, which are a conductive adhesive, the positioning pins 8 and the GND terminals 9 are electrically connected. As a result, the noise on the positive-pole bus bar 5a and the negative-pole bus bar 5b can be bypassed to the housing 104, so that the noise is filtered. Furthermore, the above arrangement can achieve both the positioning of the adhesive containers 10 on the housing 104 and the connection between the first connection members 7 and the housing 104.

The housing 104 is also connected to the Y capacitors 4 at portions other than the step portion 104a, and is connected to the bottom surfaces (the surface on the lower side in FIG. 5) of the Y capacitors 4 with a second connection member 7a. Thus, the Y capacitors 4 are fixed to the housing 104.

The first connection member 7 to fill the first adhesive containers 10 becomes to have resistance when the first connection member 7 is made to fill the containers 10 and electrically connected between the GND terminals 9 and the housing 104. By adjusting the filling amounts of the first connection members 7, it is possible to obtain a desired damping resistance value that does not deteriorate the noise performance. This is because the first connection member 7 has a specific resistivity inherent to the material as a conductive adhesive, and, by using such a property, adjustment to a desired damping resistance value is possible. Furthermore, since the first connection member 7 is made to fill the containers 10, the first connection member 7 is prevented from adhering to an unnecessary part of the housing 104.

The first connection member 7 may be formed by mixing two types of liquids. That is, it is possible to form each first connection member 7 by mixing two types of adhesives in one of the containers 10 after the first adhesive container 10 is positioned on the housing 104. Therefore, there is no need for a step in which two types of first connection members 7 are mixed in advance and then are made to fill the containers 10; therefore, a degree of freedom of the entire process is improved, and at the same time, the productivity is improved.

Furthermore, the present invention is a device including: a DC bus bar 5 that includes a positive-pole bus bar 5a and a negative-pole bus bar 5b and supplies DC power to a switching element that converts DC power into AC power; a housing 104 that is made of metal and houses the switching element; and Y capacitors 4 that connects the DC bus bar 5 and the housing 104. As a manufacturing process of the present device, the following process is adopted. Forming on the housing 104 a step portion 104a that protrudes on an upper part of the housing 104; connecting electrically the Y capacitors 4 and the step portion 104a with first connection members 7 that are a thermosetting resin and a conductive adhesive and fill first adhesive containers 10; connecting electrically the Y capacitor 4 and the housing 104 with a second connection member 7a that fills a filling portion 19 formed, in the housing 104, at a portion different from the step portion 104a; and heating simultaneously the first connection members 7 and the second connection member 7a.

By adopting such a manufacturing process, a resin curing step by heating only needs to be performed once, so that it is possible to prevent an increase in assembling time. As the second connection member 7a, a formed in place gasket (FIPG) is used, for example. As the second connection member 7a, it is possible not only to use an adhesive of a type different from that of the first connection member 7 but also to use a conductive adhesive similar to that of the first connection member 7, so that the cost can be reduced.

The configuration of the present invention does not need the metal members or other members that have been conventionally used for the Y capacitors 4 weld the GND terminals 9. Furthermore, by mounting the Y capacitors 4 on the housing 104 at low cost, resonance can be attenuated. As a result, it is possible to provide the power conversion device 200 that achieves both low noise and low cost.

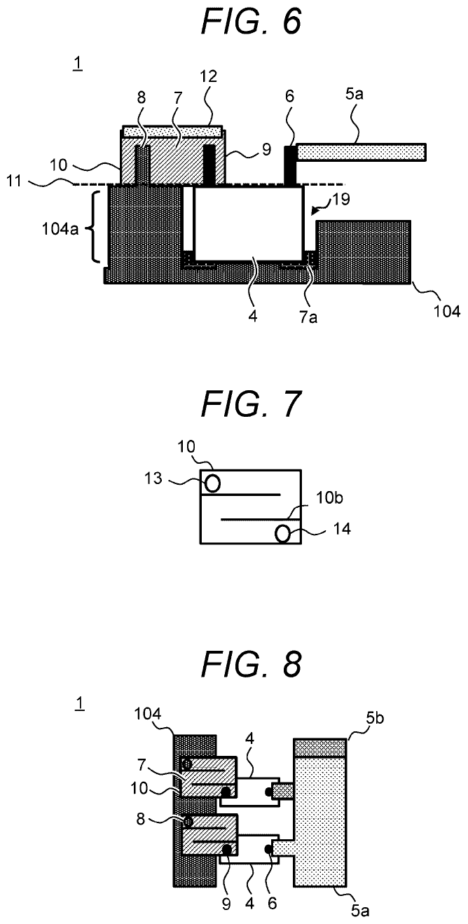

### (FIG. 6)

The first adhesive container 10 may include, as a lid of the container 10, a resin lid 12 on its upper part to address contamination, and the resin lid 12 seals the first connection member 7 in the container 10. Thus, the first connection member 7 can be prevented from leaking or scattering from the container 10. In addition, the vibration resistance of the container 10 is improved, so that adhesion to the GND terminal 9 and the positioning pin 8 is maintained.

Furthermore, since the first adhesive container 10 is placed on a reference line 11 (on a plane) formed by the upper part surface of the Y capacitor 4 and an upper part surface of the step portion 104a, not only the arrangement of the first adhesive container 10 can be limited on the housing 104, but also filling is performed such that the first connection member 7 in the container 10 forms a flat plane; therefore, the first connection member 7 is not accumulated unevenly. As a result, the positioning pin 8 and the GND terminal 9 can be bonded to each other by the first connection member 7 at substantially the same height in the container 10. In addition, stress in the first connection member 7 due to vibration is also distributed, and the vibration resistance can be expected to be improved.

### (FIGS. 7 and 8)

As illustrated in the drawings, each first adhesive container 10 may have a plurality of internal walls 10b, and the first adhesive container 10 may be filled with the first connection member 7 such that the first connection member 7 is folded along the plurality of internal walls 10b in the first adhesive container 10. In order to adjust the damping resistance value on the basis of the filling amount of the first connection member 7 in the container 10, the damping resistance value may be adjusted, as described above, by adjusting the length of a filled portion in the container 10 while considering to achieve both an increase in resistance and low inductance. In addition, with such a configuration, the current flowing through the first connection member 7 flows in the directions opposite to each other at the folded portions of the container 10, so that the magnetic flux is canceled, thereby contributing to a reduction in the inductance. That is, not only the adjustment of the resistance value can be achieved, but also both an increase in the resistance and low inductance can be achieved.

It is illustrated in the drawings that each first adhesive container 10 is provided with: a through-hole 13 for inserting therethrough one of the positioning pins 8 for fixing the first adhesive container 10 to the housing 104 described above; and a through-hole 14 for one of the GND terminals 9. With regard to the through-holes 13 and 14, by providing two through-holes in the container 10, the first adhesive container 10 can be positioned on the housing 104, and mounting can be facilitated. Furthermore, the diameter of the through-hole 13 may be larger than the diameter of the positioning pin 8 by 2 mm or more so as to intentionally allow the first connection member 7 inside the adhesive container 10 to leak out to a part under the adhesive container 10 so that the adhesive container 10 is fixed to the housing 104 and the Y capacitor 4 over a larger area. This arrangement improves vibration resistance of the container 10.

### First Modification

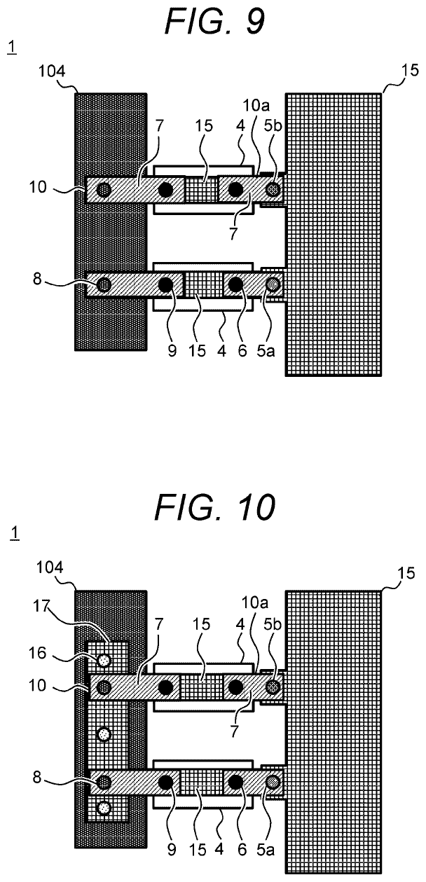

### (FIG. 9)

In the filter circuit 1, the first terminal 9 of each of the Y capacitors 4 is inserted into the through-hole of one of the first adhesive containers 10, and the second terminal 6 is inserted into the through-hole formed in one of second adhesive containers 10a connected to the DC bus bar 5. At this time, the second terminals 6 and the DC bus bar 5 are electrically connected with the first connection members 7 filling the second adhesive containers 10a. The first connection members 7 and the containers 10a are provided also for the connection between the HV terminals 6 and the DC bus bars 5a and 5b as described above, welding is not necessary to connect between the HV terminals 6 and the DC bus bars 5a and 5b.

In addition, the second adhesive containers 10a may be formed as parts of a resin 15 for molding the DC bus bars 5a and 5b, so that it is possible to reduce cost for newly manufacturing the second adhesive containers 10a, and low cost can therefore be achieved.

### Second Modification

### (FIG. 10)

A fixing member 17 is disposed between the first adhesive containers 10 and the step portion 104a of the housing 104. If the positions of the containers 10 are determined by something other than the positioning pins 8 of the housing 104, the positioning pins 8 may be replaced by bolts 16, whereby the containers 10 are fixed to the step portion 104a. This arrangement further improves the fixation performance of the first adhesive containers 10 to the housing 104.

### Third Modification

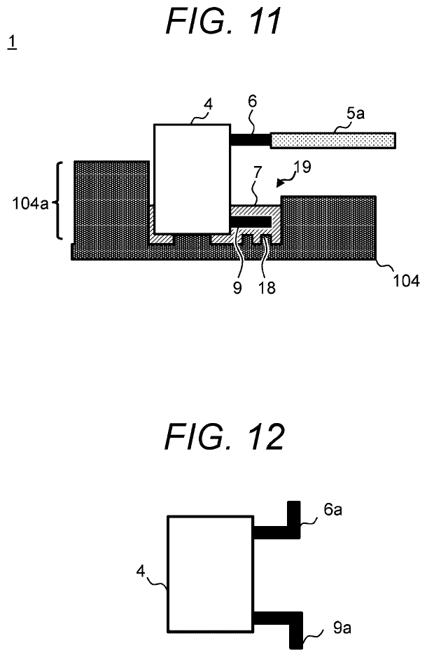

### (FIG. 11)

The housing 104 may include a connection member filling portion 19 that is filled with the first connection member 7. Since the housing 104 has only a recess that stores (can be filled with) the conductive first connection member 7, the GND terminal 9 of the Y capacitor 4 is electrically connected and fixed to the housing 104 through the first connection member 7. In addition, the housing 104 has a minute uneven portion 18. When it is desired to adjust the damping resistance by increasing or decreasing the resistance value between the GND terminal 9 and the housing 104, the increase or decrease in the resistance value can be realized by increasing or decreasing the surface area by increasing or decreasing the minute uneven portion 18. As described above, even in a case of a configuration in which the adhesive container 10 is not used, noise from the DC bus bars 5a and 5b can be released.

### Fourth Modification

### (FIG. 12)

The GND terminal 9 and the HV terminal 6 of the Y capacitor 4 may be an L-shaped (bent-shaped) GND terminal 9a and HV terminal 6a that have been subjected to bending processing. This arrangement can increase a welding area between the positive-pole bus bar 5a and the HV terminal 6 when the Y capacitor 4 having an L shape is applied to the configuration of FIG. 11. Furthermore, since the GND terminal 9a is close to the housing 104, the first connection member 7 can be reduced. In addition, in the housing 104, the Y capacitor 4 is durable against shaking in the left-right direction in the drawing.

In a case where the L-shaped Y capacitor 4 is applied to the configuration of FIGS. 4 and 5, the through-holes of the adhesive containers 10 may have such a size that the GND terminals 9 pass through the through-holes, and the GND terminals 9 do not have a straight line shape; therefore, with respect to a stress generated by a vibration in the vertical direction or the lateral direction, the GND terminals 9 have a structure perpendicular to each of the vibration directions, so that vibration resistance is improved.

The embodiment of the present invention described above provides the following action and effect.
(1) A power conversion device 200 includes: a power module 150 including a switching element that converts DC power into AC power; a DC bus bar 5 that supplies the DC power to the switching element; a housing 104 that is made of metal and houses the switching element; and a Y capacitor 4 that connects the DC bus bar 5 and the housing 104, in which the Y capacitor 4 and the housing 104 are electrically connected with a first connection member 7 that is a conductive adhesive. This configuration can provide the power conversion device 200 that achieves both low noise and low cost.
(2) The first connection member 7 fills a non-conductive first adhesive container 10. This configuration makes it possible to perform adjustment to a desired damping resistance value.
(3) The housing 104 includes a step portion 104a protruding on an upper part of the housing 104, and a bottom surface of the first adhesive container 10 is installed on a reference line 11 defined by an upper part surface of the Y capacitor 4 and an upper part surface of the step portion 104a. With this configuration, the first connection member 7 can fill so as to form a flat surface without being unevenly distributed inside the container 10, and vibration resistance can therefore be improved.
(4) The bottom surface of the first adhesive container 10 is in contact with the step portion 104a. This configuration can achieve low inductance and low noise.
(5) The first adhesive container 10 has a through-hole 13 through which a positioning pin 8 for fixing the first adhesive container 10 to the housing 104 is inserted. With this configuration, mounting can be easy.
(6) The diameter of the through-hole 13 is larger than the diameter of the positioning pin 8 by 2 mm or more. This configuration can improve fixation performance and the vibration resistance.
(7) The Y capacitor 4 has a first terminal 9 and a second terminal 6, the first terminal 9 is inserted into the through-hole 14 of the first adhesive container 10, the second terminal 6 is inserted into a through-hole formed in a second adhesive container 10a connected to the DC bus bar 5, the second terminal 6 and the DC bus bar 5 are electrically connected with the first connection member 7 filling the second adhesive container 10a. This configuration eliminates the need for welding.
(8) The second adhesive container 10a is formed as a part of a resin 15 with which the DC bus bar 5 is molded. With this configuration, the adhesive container 10 can be reduced, and the cost can therefore be reduced.
(9) The first adhesive container 10 has a resin lid 12 on its upper part. This configuration makes it possible to implement countermeasures against contamination.
(10) The first adhesive container 10 has a plurality of internal walls 10b, and the first connection member 7 fills the first adhesive container 10 so as to be folded along the plurality of internal walls 10b in the first adhesive container 10. This configuration can reduce inductance.
(11) The first adhesive container 10 is fixed to the step portion 104a with a bolt 16. This configuration makes it possible to implement a countermeasure against vibration.
(12) The housing 104 has a connection member filling portion 19 that is filled with the first connection member 7. With this configuration, the container 10 can be reduced, and the cost can therefore be reduced.
(13) A power conversion device 200 includes: a DC bus bar that supplies DC power to a switching element that converts DC power into AC power; a housing 104 that is made of metal and houses the switching element; and a Y capacitor 4 that connects the DC bus bar 5 and the housing 104. Furthermore, the following steps are performed: forming on the housing 104 a step portion 104a that protrudes on an upper part of the housing 104; connecting electrically the Y capacitor 4 and the step portion 104a with a first connection member 7 that is a thermosetting resin and a conductive adhesive and fills first adhesive container 10; connecting electrically the Y capacitor 4 and the housing 104 with a second connection member 7a that fills a filling portion 19 formed, in the housing 104, at a portion different from the step portion 104a; and heating simultaneously the first connection member 7 and the second connection member 7a. By adopting the above method for manufacturing the power conversion device 200, the steps can be made simple, and both low noise and low cost are achieved.
(14) The first connection member 7 is formed by mixing two types of liquids in the first adhesive container 10. By this method, the type of adhesive of the first connection member 7 can be limited, and the degree of freedom in the assembly process is therefore improved.

Note that the present invention is not limited to the above embodiment, and various modifications and other configurations can be combined without departing from the gist of the present invention. In addition, the present invention is not limited to one including all the configurations described in the above embodiment, and includes one in which a part of the configuration is removed.

### REFERENCE SIGNS LIST

1 filter circuit
4 Y capacitor
5 HV bus bar
5a positive-pole bus bar
5b negative-pole bus bar
6 HV terminal (second terminal)
6a L-shaped HV terminal
7 first connection member
7a second connection member
8 positioning pin
9 GND terminal (first terminal)

9a L-shaped GND terminal
10 first adhesive container
10a second adhesive container
10b internal wall
11 reference line
12 resin lid
13 hole for positioning pin
14 hole for GND terminal
15 molding resin
16 bolt
17 fixing member
18 minute uneven portion
19 connection member filling portion
104 housing
104a step portion

1. A power conversion device comprising:
a power module including a switching element that converts DC power into AC power;
a DC bus bar that supplies the DC power to the switching element;
a housing that is made of metal and houses the switching element; and
a capacitor that connects the DC bus bar and the housing,
wherein the capacitor and the housing are electrically connected with a first connection member that is a conductive adhesive.

2. The power conversion device according to claim 1, further comprising a first adhesive container that is non-conductive and filled with the first connection member.

3. The power conversion device according to claim 2, wherein
the housing includes a step portion protruding on an upper part of the housing, and
a bottom surface of the first adhesive container is installed on a reference line defined by an upper part surface of the capacitor and an upper part surface of the step portion.

4. The power conversion device according to claim 3, wherein a bottom surface of the first adhesive container is in contact with the step portion.

5. The power conversion device according to claim 2, wherein the first adhesive container has a through-hole through which a positioning pin for fixing the first adhesive container to the housing is inserted.

6. The power conversion device according to claim 5, wherein the through-hole has a diameter that is larger than a diameter of the positioning pin by 2 mm or more.

7. The power conversion device according to claim 5, wherein
the capacitor has a first terminal and a second terminal,
the first terminal is inserted into the through-hole of the first adhesive container,
the second terminal is inserted into a through-hole formed in a second adhesive container connected to the DC bus bar, and
the second terminal and the DC bus bar are electrically connected with the first connection member filling the second adhesive container.

8. The power conversion device according to claim 7, wherein the second adhesive container is formed as a part of a resin with which the DC bus bar is molded.

9. The power conversion device according to claim 2, wherein the first adhesive container has a resin lid on an upper part of the first adhesive container.

10. The power conversion device according to claim 2, wherein
the first adhesive container has a plurality of internal walls, and
the first connection member fills the first adhesive container such that the first connection member is folded back along the plurality of internal walls.

11. The power conversion device according to claim 3, wherein the first adhesive container is fixed to the step portion with a bolt.

12. The power conversion device according to claim 1, wherein the housing includes a connection member filling portion that is filled with the first connection member.

13. A method for manufacturing a power conversion device that includes:
a DC bus bar that supplies DC power to a switching element that converts the DC power into AC power;
a housing that is made of metal and houses the switching element; and
a capacitor that connects the DC bus bar and the housing,
the method comprising:
forming on the housing a step portion that protrudes on an upper part of the housing;
connecting electrically the capacitor and the step portion with a first connection member that is a thermosetting resin and a conductive adhesive and fills a first adhesive container;
connecting electrically the capacitor and the housing with a second connection member that fills a filling portion formed, in the housing, at a portion different from the step portion; and
heating simultaneously the first connection member and the second connection member.

14. The method for manufacturing a power conversion device according to claim 13, wherein the first connection member is formed by mixing two types of liquids in the first adhesive container.
